(19) United States
(12) Patent Application Publication
(10) Pub. No.: US 2025/0304012 A1
(43) Pub. Date: Oct. 2, 2025

(54) Rechargeable Key Fob Device

(71) Applicant: Brian Blackington, Corpus Christi, TX (US)

(72) Inventor: Brian Blackington, Corpus Christi, TX (US)

(21) Appl. No.: 19/043,695

(22) Filed: Feb. 3, 2025

Related U.S. Application Data
(60) Provisional application No. 63/572,941, filed on Apr. 2, 2024.

(51) Int. Cl. B60R 25/40; H01M 10/44; H02J 7/00

(52) U.S. Cl. CPC B60R 25/406; H01M 10/44; H02J 7/00302; H02J 2207/30

(57) ABSTRACT

A rechargeable key fob device is disclosed, which is a modified key fob for vehicles comprised of multiple charging ports integrated directly into the body of the fob. The rechargeable key fob device comprises a fob component with at least one charging port integrated into it. Specifically, there are two versions of the device, with one version including its own charging port and specialized cord for charging. The second version includes multiple common existing ports, such as USB A, USB C, and lightning ports. Users can simply plug the fob into a desired charging cord, then into an electrical outlet. The internal battery is charged to prevent a user from having to take apart the key fob and replace its battery.

### CROSS-REFERENCE TO RELATED APPLICATION

The present application claims priority to, and the benefit of, U.S. Provisional Application No. 63/572,941, which was filed on Apr. 2, 2024, and is incorporated herein by reference in its entirety.

### FIELD OF THE INVENTION

The present invention relates generally to the field of rechargeable key fob devices. More specifically, the present invention relates to a rechargeable key fob compatible with multiple charging cords to recharge its internal battery. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in rechargeable key fob devices. Generally, most modern vehicles are sold with a key fob to wirelessly lock and unlock doors from a distance. The key fob is powered via a small internal battery, and if the battery loses its charge, replacing it is nearly impossible. The fob must be taken apart to replace the battery, and if not done properly, the entire fob needs to be replaced. Further, buying new key fobs is much more expensive than a simple battery change.

Push button start features are now the most commonly used ignition in modern automobiles. The likelihood of the push start button effectiveness, however, is highly dependent upon the battery power source used in the fob. If a key fob has a low or dead battery, the system likely won't be able to recognize when the fob is either near or inside the car, and accordingly, won't start the engine. If a person does not have access to swap the dead battery with a new one, their only recourse is to remain stranded as they await a tow and/or professional aide.

Accordingly, there is a demand for an improved rechargeable key fob device that allows users to easily recharge the key fob battery instead of replacing it. More particularly, there is a demand for a rechargeable key fob device that offers a way for people to maintain access to their vehicles via the key fob for the entire life of the vehicle.

Therefore, there exists a long felt need in the art for a rechargeable key fob device that provides users with a rechargeable key fob compatible with multiple charging cords to recharge its internal battery. There is also a long felt need in the art for a rechargeable key fob device that features multiple versions that accommodate standard USB charging ports, USB A and USB C ports, and more. Further, there is a long felt need in the art for a rechargeable key fob device that allows users to easily recharge the key fob battery instead of taking it apart and reassembling it to replace the battery. Moreover, there is a long felt need in the art for a device that offers a way for people to maintain access to their vehicles via the key fob for the entire life of the vehicle. Further, there is a long felt need in the art for a rechargeable key fob device that provides a version that includes its own charging port and specialized cord for charging. Finally, there is a long felt need in the art for a rechargeable key fob device that allows users to simply plug the fob into a desired charging cord then into an electrical outlet to charge the battery.

The subject matter disclosed and claimed herein, in one embodiment thereof, comprises a rechargeable key fob device. The device is a modified key fob for vehicles comprised of multiple charging ports integrated directly into the body of the fob. The rechargeable key fob device comprises a fob component with at least one charging port integrated into it. Specifically, there are two versions of the device, with one version including its own charging port and specialized cord for charging. The second version includes multiple common existing ports, such as USB A, USB C, and lightning ports. Users can simply plug the fob into a desired charging cord, then into an electrical outlet. The internal battery is charged to prevent a user from having to take apart the key fob and replace its battery.

In this manner, the rechargeable key fob device of the present invention accomplishes all of the forgoing objectives and provides users with a device that provides a key fob compatible with multiple charging cords. The device is a key fob integrated with multiple charging ports. The device is simply plugged into an electrical outlet to be charged.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rechargeable key fob device. The rechargeable key fob device comprises a fob component with at least one charging port integrated into it. Users can simply plug the fob into a desired charging cord, then into an electrical outlet. The internal battery is charged to prevent a user from having to take apart the key fob and replace its battery.

In one embodiment, the rechargeable key fob device is a modified key fob that is rechargeable. The rechargeable key fob device allows users to easily recharge the key fob battery instead of taking it apart and reassembling it to replace the battery. Thus, the device offers a way for people to maintain access to their vehicles via the key fob for the entire life of the vehicle.

In one embodiment, the rechargeable key fob device comprises a fob component. The fob component typically includes a housing, a printed circuit board (PCB), and one or more switches. The housing can be generally oval or rectangular-shaped and can be constructed from plastic. In other embodiments, the housing can be constructed from a composite material, a metal, or another suitable material. The housing can include a valet hook for hanging up the fob component. The housing can include a cylindrical recess that can receive a battery and a battery access door. The housing can include an elongated aperture that can receive a mechanical key blade.

The PCB can be shaped according to the shape of the interior portion of the housing. The PCB can include electrical components that allow the key fob to control various functions of a vehicle. These functions can include, but are not limited to, remotely actuating door locks, a trunk lock, lights, and a vehicle ignition. The PCB can include an antenna (not shown), a controller (not shown), and one or more switches. The PCB can receive power from the battery.

In one embodiment, the rechargeable key fob device offers a modified fob adaption that helps eliminate the need for individuals to constantly purchase new batteries for their auto key fob by providing them with a rechargeable vehicle key fob to ensure complete functionality, at all times. With the help of the rechargeable key fob device, consumers will never have to deal with the inconvenience of a dead key fob charger that would otherwise prevent them from starting their cars as the ability to conveniently charge their fobs at any time, serves to guarantee their automobiles are fully accessible.

In one embodiment, the rechargeable key fob device comprises a rechargeable battery and at least one charge port integrated into the housing. The charge port can be any suitable shape and size and is typically shaped and sized to accept a charging cord, allowing a user to plug in one end of the charging cord into the charge port and the opposing end of the charging cord is plugged into a wall outlet to charge the key fob's rechargeable battery. Further, the fob component comprises circuitry and/or additions to the PCB to allow for the recharging of the battery and to protect the battery from incorrect voltage. The rechargeable battery is charged to prevent a user from having to take apart the fob component and replace its battery. The fob component comprises at least one charge port but can include multiple charge ports of various shapes and sizes and corresponding circuitry to allow for compatibility with various common charging cords.

In one embodiment, the fob component comprises its own specialized charge port and specialized cord for charging. In this embodiment, the fob component can comprise multiple charge ports, as needed, all with specialized cords, etc., for charging the rechargeable battery.

In another embodiment, the fob component comprises multiple common existing ports, such as USB A, USB C, and lightning ports, etc. Users can simply plug the fob into a desired charging cord, then into an electrical outlet for charging the rechargeable battery. Thus, the user is prevented from having to take apart the key fob and physically replace its battery.

In one embodiment, the fob component comprises circuitry or additions to the PCB to communicate with the rechargeable battery and to prevent overcharging, such that the charging is cut off from the battery, when it is fully charged.

In yet another embodiment, the rechargeable key fob device comprises a plurality of indicia.

In yet another embodiment, a method of recharging the battery of a key fob is disclosed. The method includes the steps of providing a rechargeable key fob device comprising a fob component with integrated charge ports. The method also comprises plugging in a corresponding power cord to one of the integrated charge ports. Further, the method comprises plugging the other end of the corresponding power cord into an electrical outlet. The method also comprises charging the key fob via the charge port and corresponding power cord. Finally, the method comprises removing the corresponding power cord, once the key fob is charged.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one embodiment of the rechargeable key fob device of the present invention showing the top of the fob component in version one in accordance with the disclosed architecture;

FIG. 1B illustrates a perspective view of one embodiment of the rechargeable key fob device of the present invention showing the bottom of the fob component with its own charging ports in accordance with the disclosed architecture;

FIG. 2A illustrates a perspective view of one embodiment of the rechargeable key fob device of the present invention showing the top of the fob component in version two in accordance with the disclosed architecture;

FIG. 2B illustrates a perspective view of one embodiment of the rechargeable key fob device of the present invention showing the bottom of the fob component with USB A, USB C and lightning ports for charging in accordance with the disclosed architecture;

FIG. 3 illustrates a perspective view of one embodiment of the rechargeable key fob device of the present invention showing a user replacing a battery on a conventional key fob in accordance with the disclosed architecture; and

FIG. 4 illustrates a flowchart showing the method of recharging the battery of a key fob in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a rechargeable key fob device that provides users with a rechargeable key fob compatible with multiple charging cords to recharge its internal battery. There is also a long felt need in the art for a rechargeable key fob device that features multiple versions that accommodate standard USB charging ports, USB A and USB C ports, and more. Further, there is a long felt need in the art for a rechargeable key fob device that allows users to easily recharge the key fob battery instead of taking it apart and reassembling it to replace the battery. Moreover, there is a long felt need in the art for a device that offers a way for people to maintain access to their vehicles via the key fob for the entire life of the vehicle. Further, there is a long felt need in the art for a rechargeable key fob device that provides a version that includes its own charging port and specialized cord for charging. Finally, there is a long felt need in the art for a rechargeable key fob device that allows users to simply plug the fob into a desired charging cord then into an electrical outlet to charge the battery.

The present invention, in one exemplary embodiment, is a novel rechargeable key fob device. The rechargeable key fob device comprises a fob component with at least one charging port integrated into it. Specifically, there are two versions of the device, with one version including its own charging port and specialized cord for charging. The second version includes multiple common existing ports, such as USB A, USB C, and lightning ports. Users can simply plug the fob into a desired charging cord, then into an electrical outlet. Further, the device may be charged wirelessly. The present invention also includes a novel method of recharging the battery of a key fob. The method includes the steps of providing a rechargeable key fob device comprising a fob component with integrated charge ports. The method also comprises plugging in a corresponding power cord to one of the integrated charge ports. Further, the method comprises plugging the other end of the corresponding power cord into an electrical outlet. The method also comprises charging the key fob via the charge port and corresponding power cord. Finally, the method comprises removing the corresponding power cord, once the key fob is charged.

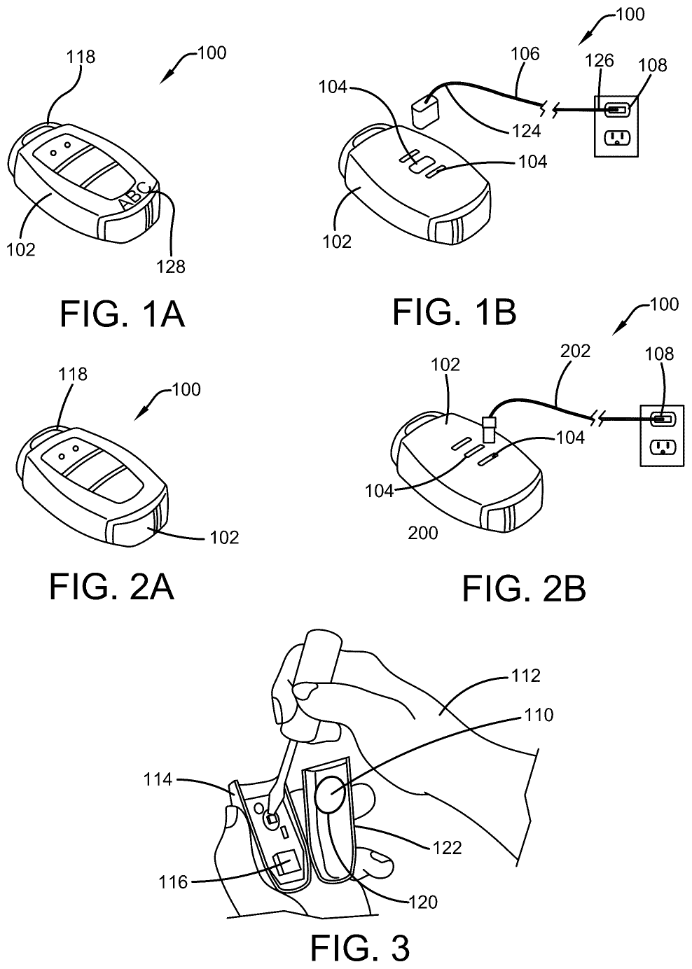

Referring initially to the drawings, FIGS. 1A-B illustrate a perspective view of one embodiment of the rechargeable key fob device 100 of the present invention. In the present embodiment, the rechargeable key fob device 100 is an improved rechargeable key fob device 100 that provides a user 112 with a modified key fob for vehicles. Specifically, the rechargeable key fob device 100 comprises a fob component 102 with an integrated charge port 104. Users can simply plug the fob component 102 into a desired charging cord 106, then into an electrical outlet 108. The internal battery 110 is charged to prevent a user 112 from having to take apart the fob component 102 and replace its battery 110.

Generally, the rechargeable key fob device 100 is a modified key fob that is rechargeable. The rechargeable key fob device 100 allows users 112 to easily recharge the key fob battery 110 instead of taking it apart and reassembling it to replace the battery 110. Thus, the device 100 offers a way for people to maintain access to their vehicles via the key fob for the entire life of the vehicle.

Further, the rechargeable key fob device 100 comprises a fob component 102. The fob component 102 typically includes a housing 114, a printed circuit board (PCB) 116, and one or more switches. The housing 114 can be generally oval or rectangular-shaped and can be constructed from plastic. In other embodiments, the housing 114 can be constructed from a composite material, a metal, or another suitable material. The housing 114 can include a valet hook 118 for hanging up the fob component 102. The housing 114 can include a cylindrical recess 120 that can receive a battery 110 and a battery access door 122. The housing 114 can include an elongated aperture that can receive a mechanical key blade (not shown).

Additionally, the PCB 116 can be shaped according to the shape of the interior portion of the housing 114. The PCB 116 can include electrical components that allow the key fob to control various functions of a vehicle. These functions can include, but are not limited to, remotely actuating door locks, a trunk lock, lights, and a vehicle ignition. The PCB 116 can include an antenna (not shown), a controller (not shown), and one or more switches. The PCB 116 can receive power from the battery 110.

Furthermore, the rechargeable key fob device 100 comprises a rechargeable battery 110 and at least one charge port 104 integrated into the housing 114. The charge port 104 can be any suitable shape and size and is typically shaped and sized to accept a charging cord 106, allowing a user 112 to plug in one end 124 of the charging cord 106 into the charge port 104 and the opposing end 126 of the charging cord 106 is plugged into a wall outlet 108 to charge the key fob's rechargeable battery 110. Further, the fob component 102 comprises circuitry and/or additions to the PCB 116 to allow for the recharging of the battery 110 and to protect the battery 110 from incorrect voltage. The rechargeable battery 110 is charged to prevent a user 112 from having to take apart the fob component 102 and replace its battery 110. The fob component 102 comprises at least one charge port 104 but can include multiple charge ports 104 of various shapes and sizes and corresponding circuitry to allow for compatibility with various common charging cords 106.

In one embodiment, the fob component 102 comprises its own specialized charge port 104 and specialized cord 106 for charging. In this embodiment, the fob component 102 can comprise multiple charge ports 104, as needed, all with specialized cords 106, etc., for charging the rechargeable battery 110.

In yet another embodiment, the rechargeable key fob device 100 comprises a plurality of indicia 128. The fob component 102 of the device 100 may include advertising, a trademark, or other letters, designs, or characters, printed, painted, stamped, or integrated into the fob component 102, or any other indicia 128 as is known in the art. Specifically, any suitable indicia 128 as is known in the art can be included, such as but not limited to, patterns, logos, emblems, images, symbols, designs, letters, words, characters, animals, advertisements, brands, etc., that may or may not be key fob, battery, or brand related.

As shown in FIGS. 2A-B, in another embodiment, the fob component 102 comprises multiple common existing ports 200, such as USB A, USB C, and lightning ports, etc. Users 112 can simply plug the fob component 102 into a desired charging cord 202, then into an electrical outlet 108 for charging the rechargeable battery 110. Thus, the user 112 is prevented from having to take apart the fob component 102 and physically replace its battery 110.

In another embodiment, the fob component 102 comprises circuitry or additions to the PCB 116 to communicate with the rechargeable battery 110 and to prevent overcharging, such that the charging is cut off from the battery 110, when it is fully charged.

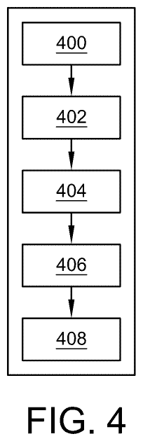

As shown in FIG. 3, the rechargeable key fob device 100 offers a modified fob adaption that helps eliminate the need for individuals to constantly purchase new batteries 110 for their auto key fob by providing them with a rechargeable vehicle key fob device 100 to ensure complete functionality, at all times. With the help of the rechargeable key fob device 100, consumers will never have to deal with the inconvenience of a dead key fob charger that would otherwise prevent them from starting their cars as the ability to conveniently charge their fobs at any time, serves to guarantee their automobiles are fully accessible and prevents the need for removing and replacing the battery 110.

FIG. 4 illustrates a flowchart of the method of recharging the battery of a key fob. The method includes the steps of at 400, providing a rechargeable key fob device comprising a fob component with integrated charge ports. The method also comprises at 402, plugging in a corresponding power cord to one of the integrated charge ports. Further, the method comprises at 404, plugging the other end of the corresponding power cord into an electrical outlet. The method also comprises at 406, charging the key fob via the charge port and corresponding power cord. Finally, the method comprises at 408, removing the corresponding power cord, once the key fob is charged.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “rechargeable key fob device”, “key fob device”, “rechargeable device”, and “device” are interchangeable and refer to the rechargeable key fob device 100 of the present invention.

Notwithstanding the forgoing, the rechargeable key fob device 100 of the present invention can be of any suitable size and configuration as is known in the art without affecting the overall concept of the invention, provided that it accomplishes the above stated objectives. One of ordinary skill in the art will appreciate that the rechargeable key fob device 100 as shown in FIGS. 1-4 is for illustrative purposes only, and that many other sizes and shapes of the rechargeable key fob device 100 are well within the scope of the present disclosure. Although the dimensions of the rechargeable key fob device 100 are important design parameters for user convenience, the rechargeable key fob device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rechargeable key fob device that provides a user with a modified key fob for vehicles, the rechargeable key fob device comprising:
a fob component; and
at least one charge port;
wherein the at least one charge port is integrated into the fob component;
wherein the fob component has a rechargeable battery; and
further wherein a charge cord is plugged into the at least one charge port and then plugged into an electrical outlet to charge the rechargeable battery.

2. The rechargeable key fob device of claim 1, wherein the fob component includes a housing, a printed circuit board (PCB), and one or more switches.

3. The rechargeable key fob device of claim 2, wherein the housing is generally oval or rectangular-shaped.

4. The rechargeable key fob device of claim 3, wherein the housing is constructed from plastic, a composite material, or a metal.

5. The rechargeable key fob device of claim 4, wherein the housing comprises a valet hook for hanging up the fob component.

6. The rechargeable key fob device of claim 5, wherein the housing comprises a cylindrical recess that receives the rechargeable battery, and a battery access door.

7. The rechargeable key fob device of claim 6, wherein the PCB includes electrical components that allow the fob component to control various functions of a vehicle, such as remotely actuating door locks, a trunk lock, lights, and a vehicle ignition.

8. The rechargeable key fob device of claim 7, wherein the housing comprises circuitry or additions to the PCB to allow for recharging of the rechargeable battery and to protect the rechargeable battery from incorrect voltage.

9. The rechargeable key fob device of claim 8, wherein the fob component comprises multiple charge ports of various shapes and sizes and corresponding circuitry to allow for compatibility with various common charging cords.

10. The rechargeable key fob device of claim 9, wherein the fob component comprises its own specialized charge port and specialized cord for charging the rechargeable battery.

11. The rechargeable key fob device of claim 10, wherein the fob component comprises multiple common existing charge ports, such as USB A, USB C, and lightning ports.

12. The rechargeable key fob device of claim 11, wherein a corresponding charge cord for the USB A, USB C, and lighting ports are used to plug into an electrical outlet for charging the rechargeable battery.

13. A rechargeable key fob device that provides a user with a modified key fob for vehicles, the rechargeable key fob device comprising:
a fob component comprising a housing, a printed circuit board (PCB), a rechargeable battery, and one or more switches; and
at least one charge port which is a USB A, USB C, or lightning port integrated into the fob component;
wherein the housing comprises a cylindrical recess that receives the rechargeable battery, and a battery access door;
wherein the PCB includes electrical components that allow the fob component to control various functions of a vehicle, such as remotely actuating door locks, a trunk lock, lights, and a vehicle ignition;
wherein the housing comprises circuitry or additions to the PCB to allow for recharging of the rechargeable battery and to protect the rechargeable battery from incorrect voltage; and
further wherein a corresponding charge cord for the USB A, USB C, and lighting ports are used to plug into an electrical outlet for charging the rechargeable battery.

14. The rechargeable key fob device of claim 13, wherein the fob component comprises multiple charge ports of various shapes and sizes and corresponding circuitry to allow for compatibility with various common charging cords.

15. The rechargeable key fob device of claim 13, wherein the fob component comprises its own specialized charge port and specialized cord for charging the rechargeable battery.

16. The rechargeable key fob device of claim 13, wherein the fob component comprises circuitry or additions to the PCB to communicate with the rechargeable battery and to prevent overcharging.

17. The rechargeable key fob device of claim 16, wherein because of the circuitry or additions to the PCB, charging is cut off from the rechargeable battery, when it is fully charged.

18. The rechargeable key fob device of claim 13 further comprising a plurality of indicia.

19. The rechargeable key fob device of claim 13, wherein the housing comprises a valet hook for hanging up the fob component.

20. A method of recharging the battery of a key fob, the method comprising the following steps:
providing a rechargeable key fob device comprising a fob component with integrated charge ports;
plugging in a corresponding power cord to one of the integrated charge ports;
plugging the other end of the corresponding power cord into an electrical outlet;
charging the key fob via the charge port and corresponding power cord; and
removing the corresponding power cord, once the key fob is charged.
